(19) United States
(12) Patent Application Publication
(10) Pub. No.: US 2020/0233094 A1
(43) Pub. Date: Jul. 23, 2020

(54) SYSTEM AND METHOD FOR POSITIONING IN URBAN CANYONS

(71) Applicant: GM GLOBAL TECHNOLOGY OPERATIONS LLC, DETROIT, MI (US)

(72) Inventors: Rakesh Kumar, Markham (CA); CURTIS L. HAY, WEST BLOOMFIELD, MI (US); Steven R. Croyle, Bingham Farms, MI (US)

(21) Appl. No.: 16/255,198

(22) Filed: Jan. 23, 2019

(51) Int. Cl. G01S 19/40; G01S 19/43; G01S 19/24; G05D 1/02

(52) U.S. Cl. CPC G01S 19/40; G05D 1/0278; G01S 19/24; G01S 19/43

(57) ABSTRACT

A method of determining position includes providing a GNSS positioning receiver, a controller, and a non-transient computer-readable data storage. The data storage is provided with at least one 3-dimensional building model having a geographical identifier. The method also includes receiving at least one GNSS position signal. The method further includes calculating an approximate position based on the at least one GNSS position signal and that a respective GNSS position signal of the at least one GNSS position signal is a non-line-of-sight signal. The method further includes calculating, based on the building model and the respective GNSS position signal, a modeled position, and refining the modeled position based on a current heading and speed of the positioning receiver and a carrier-phase of the at least one GNSS position signal. The method still further includes calculating a final position based on the approximate position, the modeled position, and the refining step.

### INTRODUCTION

The present disclosure relates generally to Global Navigation Satellite System (GNSS) positioning of moving or stationary entities. GNSS receivers, such as Global Positioning System (GPS) receivers, generally operate by tracking line of sight (LOS) signals. These receivers typically require at least four or more satellites to be continuously available in an unobstructed line of sight of a satellite receiver on a vehicle. Due to natural and man-made obstructions (e.g., buildings) or natural obstructions (i.e., dense tree cover), the optimum number of satellites required to accurately determine a position of the satellite receiver using known techniques may not be available under certain conditions. Moreover, a traditional GNSS receiver may be unable to differentiate a LOS from non-LOS signals and, if locked to non-LOS signals for tracking, may result in range errors.

### SUMMARY

A method of determining position according to the present disclosure includes providing a positioning receiver configured to receive GNSS position signals, a controller in communication with the positioning receiver, and a non-transient computer-readable data storage in communication with the controller. The method additionally includes providing the data storage with at least one 3-dimensional building model having a geographical identifier. The method also includes receiving, via the positioning receiver, at least one GNSS position signal. The method further includes calculating, via the controller, an approximate position based on the at least one GNSS position signal and determining, via the controller, that a respective GNSS position signal of the at least one GNSS position signal is a non-line-of-sight signal. The method further includes calculating, via the controller, based on the building model and the respective GNSS position signal, a modeled position, and refining, via the controller, the modeled position based on a current heading and speed of the positioning receiver and a carrier-phase of the at least one GNSS position signal. The method still further includes calculating, via the controller, a final position based on the approximate position, the modeled position, and the refining step.

In an exemplary embodiment, the method further includes defining, via the controller, a vehicle route based on the final position, and automatically controlling, via the controller, vehicle steering according to the vehicle route.

In an exemplary embodiment, the at least one GNSS position signal includes a first GNSS position signal and a second GNSS position signal. The first GNSS position signal is a non-line-of-sight signal and the second GNSS position signal is a line-of-sight signal. The respective position GNSS signal is the first GNSS position signal.

In an exemplary embodiment, the determining step is in further response to a number of GNSS satellites in line of sight communication with the positioning receiver being below a threshold.

In an exemplary embodiment, the calculating the modeled position includes identifying a plurality of candidate points having associated coordinates, calculating signal parameters at the candidate points based on the building model, and comparing the calculated signal parameters to the respective GNSS position signal.

An automotive vehicle according to the present disclosure includes a positioning receiver configured to receive GNSS position signals, a non-transient computer-readable data storage provided with at least one 3-dimensional building model having a geographical identifier, and a controller in communication with the positioning receiver and the data storage. The controller is configured to calculate an approximate position based on at least one GNSS position signal received via the positioning receiver. The controller is also configured to determine that a respective GNSS position signal of the at least one GNSS position signal is a non-line-of-sight signal, and to calculate a modeled position based on the building model and the respective GNSS position signal. The controller is additionally configured to refine the modeled position based on a current heading and speed of the positioning receiver and a carrier-phase of the at least one GNSS position signal. The controller is further configured to calculate a final position based on the approximate position, the modeled position, and the refined position.

In an exemplary embodiment, the vehicle includes at least one actuator configured to control vehicle steering, acceleration, braking, or shifting, and the controller is further configured to define a vehicle route based on the final position and to automatically control the at least one actuator to achieve the vehicle route.

In an exemplary embodiment, the at least one GNSS position signal includes a first GNSS position signal and a second GNSS position signal. The first GNSS position signal is a non-line-of-sight signal and the second GNSS position signal is a line-of-sight signal. The respective position GNSS signal is the first GNSS position signal.

In an exemplary embodiment, the controller is configured to determine that the respective GNSS position signal of the at least one GNSS position signal is a non-line-of-sight signal in further response to a number of GNSS satellites in line of sight communication with the positioning receiver being below a calibrated threshold.

In an exemplary embodiment, the controller is further configured to calculate the modeled position by identifying a plurality of candidate points having associated coordinates, calculating signal parameters at the candidate points based on the building model, and comparing the calculated signal parameters to the respective GNSS position signal.

A system for positioning an automotive vehicle according to the present disclosure includes an automotive vehicle having a positioning receiver configured to receive GNSS position signals, a non-transient computer-readable data storage provided with at least one 3-dimensional building model having a geographical identifier, and a controller in communication with the positioning receiver and the data storage. The controller is configured to calculate an approximate position based on at least one GNSS position signal received via the positioning receiver. The controller is also configured to determine that a respective GNSS position signal of the at least one GNSS position signal is a non-line-of-sight signal, and to calculate a modeled position based on the building model and the respective GNSS position signal. The controller is additionally configured to refine the modeled position based on a current heading and speed of the positioning receiver and a carrier-phase of the at least one GNSS position signal. The controller is further configured to calculate a final position based on the approximate position, the modeled position, and the refined position.

In an exemplary embodiment, the data storage and the controller are disposed in the automotive vehicle.

Embodiments according to the present disclosure provide a number of advantages. For example, the present disclosure provides a system and method for determining position based on a non-line-of sight (NLOS) signal, advantageously enabling navigation in urban canyons and other environments having obstacles which interfere with conventional satellite positioning.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a flowchart representation of a method of controlling a vehicle according to an embodiment of the present disclosure; and

FIG. 4 is an illustration of a vehicle according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

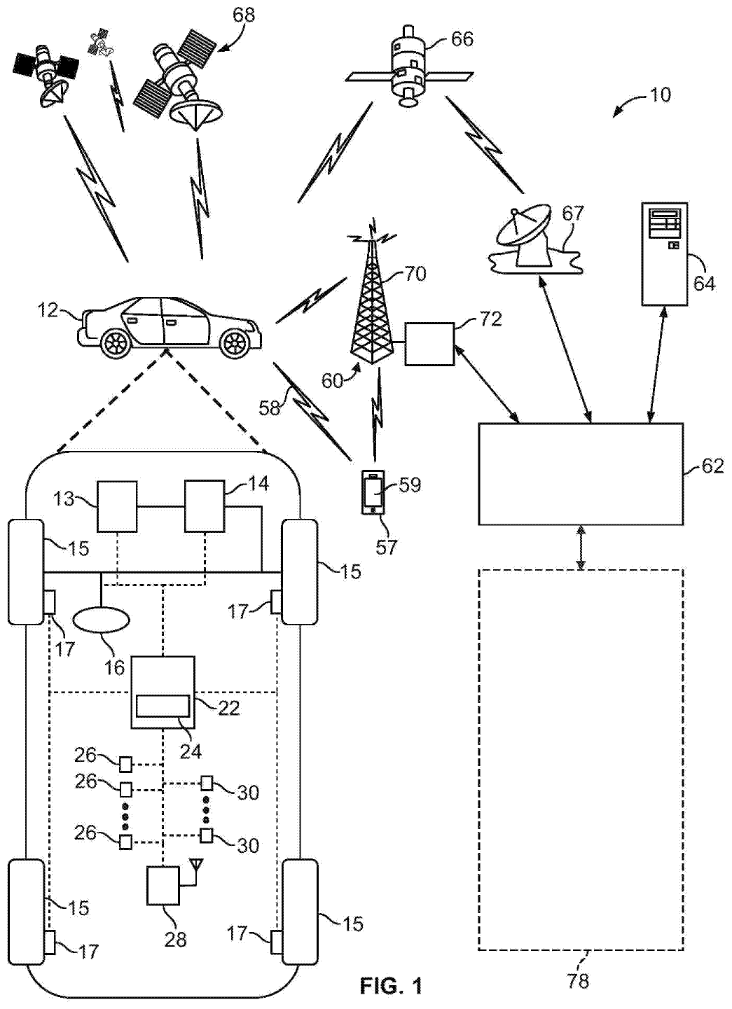

FIG. 1 schematically illustrates an operating environment that comprises a mobile vehicle communication and control system 10 for a motor vehicle 12. The motor vehicle 12 may be referred to as a host vehicle. The communication and control system 10 for the host vehicle 12 generally includes one or more wireless carrier systems 60, a land communications network 62, a computer 64, a mobile device 57 such as a smart phone, and a remote access center 78.

The host vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The host vehicle 12 includes a propulsion system 13, which may in various embodiments include an internal combustion engine, an electric machine such as a traction motor, and/or a fuel cell propulsion system.

The host vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The host vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The host vehicle 12 additionally includes a steering system 16. While depicted as including a steering wheel for illustrative purposes, in some embodiments contemplated within the scope of the present disclosure, the steering system 16 may not include a steering wheel.

The host vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 (“WiFi™”) and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific (e.g. within defined geographic boundaries) performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

Other embodiments according to the present disclosure may be implemented in conjunction with so-called Level One, Level Two, or Level Three automation systems. A Level One system indicates “driver assistance”, referring to the driving mode-specific execution by a driver assistance system of either steering or acceleration using information about the driving environment and with the expectation that the human driver performs all remaining aspects of the dynamic driving task. A Level Two system indicates “Partial Automation”, referring to the driving mode-specific execution by one or more driver assistance systems of both steering and acceleration using information about the driving environment and with the expectation that the human driver performs all remaining aspects of the dynamic driving task. A Level Three system indicates “Conditional Automation”, referring to the driving mode-specific performance by an automated driving system of all aspects of the dynamic driving task with the expectation that the human driver will respond appropriately to a request to intervene.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GNSS (global navigation satellite system, e.g. GPS and/or GLONASS), RADAR, LIDAR, optical cameras, thermal cameras, ultrasonic sensors, and/or additional sensors as appropriate.

FIG. 1 illustrates several networked devices that can communicate with the wireless communication system 28 of the host vehicle 12. One of the networked devices that can communicate with the host vehicle 12 via the wireless communication system 28 is the mobile device 57. The mobile device 57 can include computer processing capability, a transceiver capable of communicating signals 58 using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving signals from GPS satellites 68 and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The mobile device 57 may also include other sensors, including but not limited to, accelerometers capable of measuring motion of the mobile device 57 along six axes. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide unidirectional or bidirectional communication with the host vehicle 12. This can be done using one or more communication satellites 66 and an uplink transmitting station 67. Unidirectional communication can include, for example, satellite radio services, wherein programming content (news, music, etc.) is received by the transmitting station 67, packaged for upload, and then sent to the satellite 66, which broadcasts the programming to subscribers. Bidirectional communication can include, for example, satellite telephony services using the satellite 66 to relay telephone communications between the host vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the host vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the host vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the host vehicle 12. The computer 64 may be in communication with at least one supplemental vehicle in addition to the host vehicle 12. The host vehicle 12 and any supplemental vehicles may be collectively referred to as a fleet. In an exemplary embodiment, the computer 64 is configured to store, e.g. in non-transient data memory, subscriber account information and/or vehicle information. The subscriber account information can include, but is not limited to, biometric data, password information, subscriber preferences, and learned behavioral patterns of users or occupants of vehicles in the fleet. The vehicle information can include, but is not limited to, vehicle attributes such as color, make, model, license plate number, notification light pattern, and/or frequency identifiers.

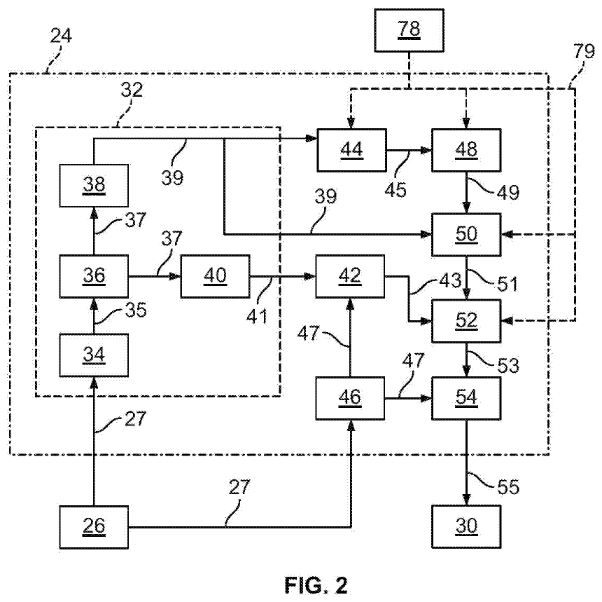

As shown in FIG. 2, the ADS 24 includes multiple distinct systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light and sign classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation module 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of the host vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the host vehicle 12 during operation and mapping data “pushed” to the host vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the host vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

As discussed above, for an autonomous vehicle it is desirable to know the precise vehicle geolocation to enable accurate navigation and path-following behavior. Conventional positioning systems determine the geolocation of a GNSS receiver based upon line-of-sight communication between the receiver and multiple GNSS satellites. Furthermore, as mentioned previously, such conventional positioning systems may be unable to differentiate a LOS from non-LOS signals and, if locked to non-LOS signals for tracking, may result in range errors.

The global positioning satellite constellation includes at least 24 or more satellites orbiting the earth in a predetermined path of travel continuously transmitting time-marked data signals. GNSS receivers receive the transmitted data and use this information to determine its absolute position. In viewing the earth in a two-dimensional plane, each point on the earth is identified by two coordinates. The first coordinate represents latitude and the second point represents a longitude. To determine a position in the two-dimensional plane, at least three satellites are required as there are three unknowns, two position unknowns and the receiver clock timing error which also treated as an unknown. Some receivers may assume that the altitude stays the same for short duration such that position can be determined with only three satellites; however, if altitude is taken into consideration which is the case for most applications, then at least a minimum of four satellites are required to estimate an absolute position with a certain amount of error. By using four or more satellites, an absolute position in a three dimensional space can be determined that includes the height above and below the earth's surface (e.g., sea level).

GNSS receivers operate by tracking line-of-sight signals which requires that each of the satellites be in view of the receiver. By design, GNSS systems ensure that on average, four or more satellites are continuously in the line-of-sight of a respective receiver on the earth. The location of a navigation satellite receiver is determined by first comparing the time the signals were transmitted from each of the respective satellites versus the time the signals were recorded and then correcting for errors, such as orbiting errors (e.g. when a satellite's reported position does not match its actual trajectory due to errors or limitations in the models used), poor geometry (e.g. satellites clustered within a narrow region of the sky with respect to the view of the receiver), atmospheric delay (e.g. delays occurring when the signals pass through the atmosphere), and clock errors (e.g. clocks built into a receiver being inaccurate or deviations in satellite clocks). In response to the comparison and the estimates of the location of each satellite using transmitted data, the receiver calculates how far away each satellite is from the receiving device. Provided this information, the receiver not only determines its position, but the receiver can determine speed, bearing, distance and time to a destination and other information.

Known positioning systems are reliant on line-of-sight (LOS) communication between the GNSS receiver and an adequate number of satellites. However, in some driving situations such as urban canyons (e.g. obstructions such as buildings) a lower number of satellites may be in the line of sight, and even more so, obstructions may result in a lower number of satellites than that which is required to accurately determine the position of the satellite receiver. Such obstructions may both reduce the sky visibility and increase the number of multipath or non-line-of-sight (NLOS) signals. Multipath refers to the phenomenon whereby a GNSS receiver receives signals from multiple paths, including reflections and refraction.

Methods of positioning according to the present disclosure make use of a three-dimensional building model (3DBM). A 3DBM includes geospatial information pertaining to a particular region, and may be generated via photogrammetry, LiDAR, or other surveying techniques as appropriate. The 3DBM includes a surface model of the area, as well as ortho-imagery which can be used to add texture information to the model. In an exemplary embodiment, the 3DBM includes a number of polygons, e.g. triangles, where each polygon represents part of a surface, e.g. of a building. Each polygon is associated with a plurality of vertices having associated 3D Cartesian coordinates.

The 3DBM may be used in conjunction with a ray-tracing algorithm to obtain information regarding LOS and NLOS signals. Ray-tracing refers to the simulation of a ray, or path followed by the signal, from the GNSS satellite to the GNSS receiver. Generally speaking, the ray-tracing algorithm simulates a signal from each satellite toward each polygon of the 3DBM and determines all possible ray-polygon intersections before reaching the GNSS receiver. In an exemplary embodiment, the ray-tracing algorithm comprises a first step and a second step. In the first step, planes defined by the polygons of the 3DBM are calculated, which may thereafter be used to find the incidence and reflected angles for rays from the satellite toward the respective polygons. In the second step, a determination is made of whether a ray reaches the receiver after reflecting from each respective polygon. The ray-tracing algorithm may thereby identify one or more NLOS signals reaching the GNSS receiver.

In a first exemplary embodiment, the 3DBM is stored in nontransient data memory in communication with the controller 22, and the ray tracing algorithm is performed in real time by the controller 22. In a second exemplary embodiment, the 3DBM is stored remotely, e.g. in data storage of the computer 64, and the ray tracing algorithm is performed remotely, e.g. by a processor of the computer 64. In such an embodiment, the simulation results may be communicated to the controller 22, e.g. via the wireless communications system 28.

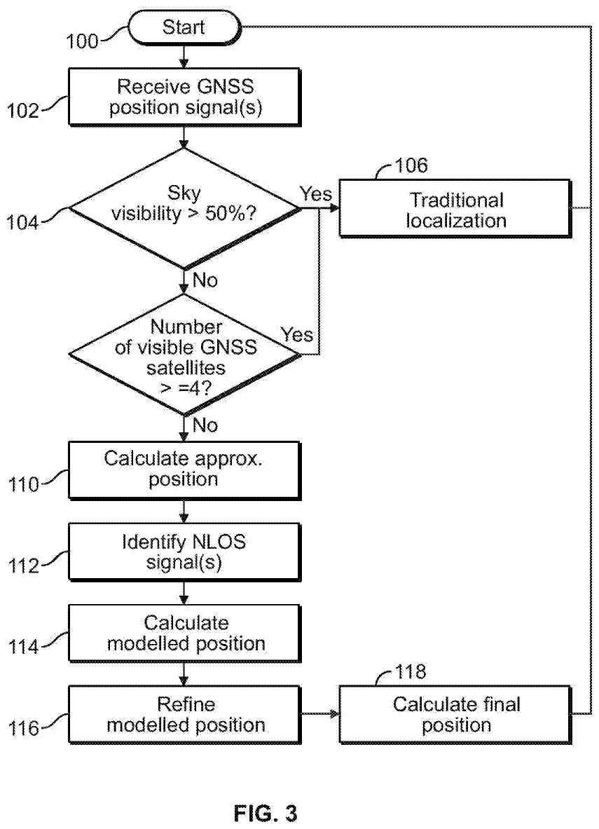

Referring now to FIG. 3, a method of determining position according to an embodiment of the present disclosure is illustrated in flowchart form. The method begins at block 100.

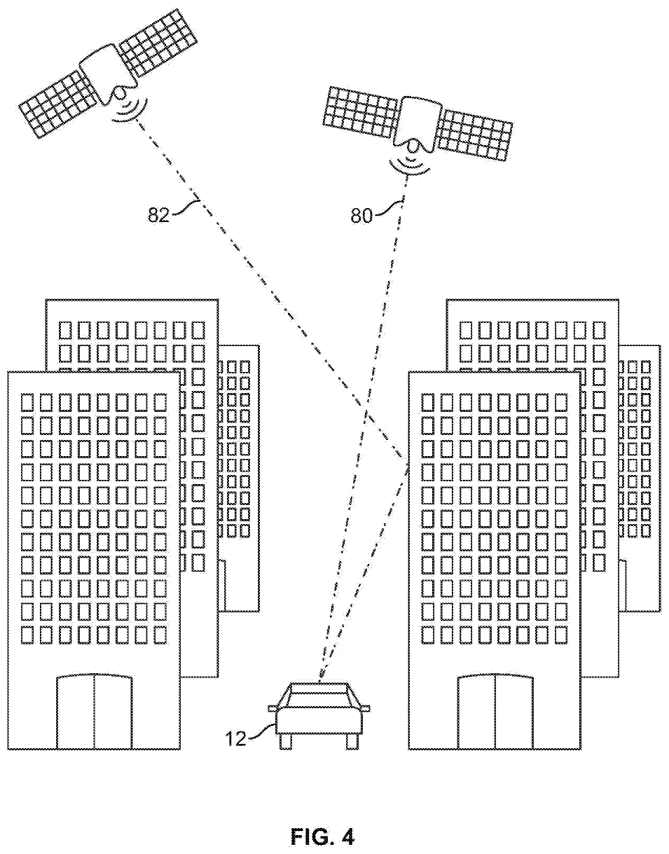

One or more GNSS position signals are received, as illustrated at block 102. In an exemplary embodiment, this is performed via one of the sensors 26 configured as a GNSS receiver, under the control of the controller 22. As illustrated schematically in FIG. 4, the vehicle 12 may receive a first position signal 80 and a second position signal 82, wherein the first position signal 80 is a LOS signal and the second position signal 82 is a NLOS signal. In the illustrated configuration the second position signal 82 reflects only a single time between the satellite and the GNSS receiver; however, in other embodiments a NLOS signal may reflect more than once.

A determination is made of whether sky visibility in the proximity of the GNSS receiver is greater than or equal to 50%, as illustrated at operation 104. In an exemplary embodiment, this is performed via a sky-visibility calculation algorithm. This algorithm takes into account the building orientation with respect to user and can determine what portion of the sky is visible, i.e. permitting LOS between the GNSS receiver and any satellites in the visible portion of the sky.

In response to the determination of operation 104 being positive, i.e. sky visibility is greater than or equal to 50%, then the position of the GNSS receiver is determined via conventional localization techniques, as illustrated at block 106. In such situations, it may be presumed that available LOS satellites are adequate to provide accurate positioning. Control then returns to block 102.

In response to the determination of operation 104 being negative, i.e. sky visibility is less than 50%, then a determination is made of whether the number of GNSS satellites in LOS with the GNSS receiver is greater than or equal to 4, as illustrated at operation 108. In an exemplary embodiment, this is performed using the ray-tracing algorithm discussed above.

In response to the determination of operation 108 being positive, i.e. the number of LOS GNSS satellites is greater than or equal to 4, then control proceeds to block 106 and the GNSS receiver is determined via conventional localization techniques. In such situations, it may be presumed that available LOS satellites are adequate to provide accurate positioning. Control then returns to block 102.

In response to the determination of operation 108 being negative, i.e. the number of LOS GNSS satellites is less than 4, then an approximate position is calculated, as illustrated at block 110. The approximate position may be obtained via a variety of methods including WiFi positioning, conventional GNSS positioning, or any other suitable method. In an exemplary embodiment, a first position grid, e.g. arranged as a cartesian plane, is then defined about the approximate position. The position grid comprises a plurality of potential geopositions for the GNSS receiver, which may be referred to as candidate points.

One or more NLOS signals are then identified, as illustrated at block 112. In an exemplary embodiment, this is performed by the controller 22 based on signals from the GNSS receiver. As discussed above, this may be performed using a 3DBM in conjunction with a ray tracing algorithm.

A modelled position is then calculated, as illustrated at block 114. In an exemplary embodiment, this calculation comprises predicting signal parameters at each candidate point of the first position grid based on the identified NLOS signal(s). In an exemplary embodiment, the predicted signal parameters are based, in part, on the code-phase and carrier-phase of the signal, a current speed of the vehicle, and a current heading of the vehicle. The predicted signal parameters are then correlated with the observed signal parameters obtained by the GNSS receiver. In an exemplary embodiment, the correlation comprises a least squares matching algorithm. The candidate point having the best match between observed signal parameter and predicted signal parameter, e.g. the least residual for a least squares matching algorithm, may be presumed to be the closest candidate point to the vehicle location.

The modelled position is then refined, as illustrated at block 116. In an exemplary embodiment, this step comprises defining a second position grid comprising candidate points, wherein the second position grid has finer spacing between candidate points than the first position grid.

A final position is then calculated, as illustrated at block 118. The final position may be obtained as an output from the refinement step of block 116. Control then returns to block 102. The algorithm thereby continues to monitor sky visibility and available satellites, and to thereby return to conventional positioning when available.

The position obtained through the algorithm illustrated in FIG. 3 may be used for any suitable positioning or navigation purposes. As a first nonlimiting example, the ADS 24 may use the position, e.g. via the absolute positioning module 42. As a second nonlimiting example, the position may be displayed via a user interface to provide location information to an occupant of the vehicle 12. The position may likewise be used in other ways as appropriate.

As may be seen, the present disclosure provides a system and method for determining position based on NLOS signal, advantageously enabling navigation in urban canyons and other environments having obstacles which interfere with conventional satellite positioning.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of determining position, comprising:
providing a positioning receiver configured to receive GNSS position signals, a controller in communication with the positioning receiver, and a non-transient computer-readable data storage in communication with the controller;
providing the data storage with at least one 3-dimensional building model having a geographical identifier;
receiving, via the positioning receiver, at least one GNSS position signal;
calculating, via the controller, an approximate position based on the at least one GNSS position signal;
determining, via the controller, that a respective GNSS position signal of the at least one GNSS position signal is a non-line-of-sight signal;
calculating, via the controller, based on the building model and the respective GNSS position signal, a modeled position;
refining, via the controller, the modeled position based on a current heading and speed of the positioning receiver and a carrier-phase of the at least one GNSS position signal; and
calculating, via the controller, a final position based on the approximate position, the modeled position, and the refining step.

2. The method of claim 1, further comprising defining, via the controller, a vehicle route based on the final position, and automatically controlling, via the controller, vehicle steering according to the vehicle route.

3. The method of claim 1, wherein the at least one GNSS position signal comprises a first GNSS position signal and a second GNSS position signal, the first GNSS position signal being a non-line-of-sight signal and the second GNSS position signal being a line-of-sight signal, the respective position GNSS signal being the first GNSS position signal.

4. The method of claim 1, wherein the determining step is in further response to a number of GNSS satellites in line of sight communication with the positioning receiver being below a calibrated threshold.

5. The method of claim 1, wherein the calculating the modeled position comprises identifying a plurality of candidate points having associated coordinates, calculating signal parameters at the candidate points based on the building model, and comparing the calculated signal parameters to the respective GNSS position signal.

6. An automotive vehicle comprising:
a positioning receiver configured to receive GNSS position signals;
a non-transient computer-readable data storage provided with at least one 3-dimensional building model having a geographical identifier; and
a controller in communication with the positioning receiver and the data storage, the controller being configured to calculate an approximate position based on at least one GNSS position signal received via the positioning receiver, determine that a respective GNSS position signal of the at least one GNSS position signal is a non-line-of-sight signal, calculate a modeled position based on the building model and the respective GNSS position signal, refine the modeled position based on a current heading and speed of the positioning receiver and a carrier-phase of the at least one GNSS position signal, and to calculate a final position based on the approximate position, the modeled position, and the refined position.

7. The vehicle of claim 6, further comprising at least one actuator configured to control vehicle steering, acceleration, braking, or shifting, wherein the controller is further configured to define a vehicle route based on the final position and to automatically control the at least one actuator to achieve the vehicle route.

8. The vehicle of claim 6, wherein the at least one GNSS position signal comprises a first GNSS position signal and a second GNSS position signal, the first GNSS position signal being a non-line-of-sight signal and the second GNSS position signal being a line-of-sight signal, the respective position GNSS signal being the first GNSS position signal.

9. The vehicle of claim 6, wherein the controller is configured to determine that the respective GNSS position signal of the at least one GNSS position signal is a non-line-of-sight signal in further response to a number of GNSS satellites in line of sight communication with the positioning receiver being below a calibrated threshold.

10. The vehicle of claim 6, wherein the controller is further configured to calculate the modeled position by identifying a plurality of candidate points having associated coordinates, calculating signal parameters at the candidate points based on the building model, and comparing the calculated signal parameters to the respective GNSS position signal.

11. A system for positioning an automotive vehicle, the system comprising:
an automotive vehicle having a positioning receiver configured to receive GNSS position signals;
a non-transient computer-readable data storage provided with at least one 3-dimensional building model having a geographical identifier; and
a controller in communication with the positioning receiver and the data storage, the controller being configured to calculate an approximate position based on at least one GNSS position signal received via the positioning receiver, determine that a respective GNSS position signal of the at least one GNSS position signal is a non-line-of-sight signal, calculate a modeled position based on the building model and the respective GNSS position signal, refine the modeled position based on a current heading and speed of the positioning receiver and a carrier-phase of the at least one GNSS position signal, and to calculate a final position based on the approximate position, the modeled position, and the refined position.

12. The system of claim 11, wherein the data storage and the controller are disposed in the automotive vehicle.
